(19) United States
(12) Patent Application Publication
(10) Pub. No.: US 2002/0149187 A1
(43) Pub. Date: Oct. 17, 2002

(54) Soft-surface inflatable knee bolster airbag

(76) Inventors: Kimberlee D. Holtz, Grand Blanc, MI (US); David W. Shneider, Waterford, MI (US)

Correspondence Address: Sally J. Brown, Autoliv ASP, Inc., 3350 Airport Road, Ogden, UT, 84405, US

(21) Appl. No.: 09/829,683

(22) Filed: Apr. 11, 2001

(51) Int. Cl. B60R 21/06; B60R 21/16

(52) U.S. Cl. 280/749; 280/728.1

(57) ABSTRACT

A soft-surface inflatable knee bolster airbag system which provides a soft surface to impact the vehicle occupant's legs and knees, uses a fixed load distribution panel to provide the necessary support to prevent sliding, is simple, easy to fabricate, and offers flexibility in the design of vehicle interiors. The soft-surface inflatable knee bolster airbag system includes a load distribution panel, an airbag curtain, an inflator configured to inflate the airbag curtain, and a housing for storage of the airbag curtain and the inflator. The airbag curtain configured such that upon inflation the airbag curtain is oriented parallel to the load distribution panel. This positioning utilizes the load distribution panel as support for the inflated airbag curtain which is absorbing the impact force imposed by the vehicle occupant's lower extremities.

### BACKGROUND OF THE INVENTION

1. The Field of the Invention

The present invention relates to airbag inflation systems in motor vehicles. More specifically, the invention relates to a soft-surface airbag for closing the space between an vehicle occupant's knees and the load distribution panel of a knee bolster.

2. Technical Background

Inflatable airbags are well accepted for use in motor vehicles and have been credited with preventing numerous deaths and accidents. Some statistics estimate that frontal airbags reduce the fatalities in head-on collisions by 25% among drivers using seat belts and by more than 30% among unbelted drivers. Statistics further suggest that with use of a combination of seat belt and airbag, serious chest injuries in frontal collisions can be reduced by 65% and serious head injuries by up to 75%. Airbag use presents clear benefits and vehicle owners are frequently willing to pay the added expense for airbags.

A modem airbag apparatus may include an electronic control unit (‘ECU’) and one or more airbag modules. The ECU is usually installed in the middle of an automobile, between the passenger and engine compartments. If the vehicle has a driver airbag only, the ECU may be mounted in the steering wheel. The ECU includes a sensor which continuously monitors the acceleration and deceleration of the vehicle and sends this information to a processor which processes an algorithm to determine if the vehicle is in an accident situation.

When the processor determines that there is an accident situation, the ECU transmits an electrical current to an initiator in the airbag module. The initiator triggers operation of the inflator or gas generator which, in some embodiments, uses a combination of compressed gas and solid fuel. The inflator inflates a textile airbag to impact a passenger and prevent injury to the passenger. In some airbag apparatuses, the airbag may be fully inflated within 50 thousandths of a second and deflated within two tenths of a second.

An airbag cover, also called a trim cover panel, covers a compartment containing the airbag module and may reside on a steering wheel, instrument panel, vehicle door, vehicle wall, or beneath the dash board. The airbag cover is typically made of a rigid plastic and may be forced open by the pressure from the deploying airbag. In deploying the airbag, it is preferable to retain the airbag cover to prevent the airbag cover from flying loose in the passenger compartment. If the airbag cover freely moves into the passenger compartment, it may injure a passenger.

Airbag apparatuses have been primarily designed for deployment in front of the torso of an occupant between the upper torso of an occupant and the windshield or instrument panel. Conventional airbags, such as driver's or passenger airbags (hereinafter referenced as the “primary airbag”), protect the occupant's upper torso and head from colliding with a windshield or instrument panel.

Airbag apparatuses are generally designed under the assumption that the occupant is riding in the vehicle in a forward facing, seated position with both feet on the vehicle floor. When an occupant is not in this position, the occupant or occupant's body part is said to be ‘out of position.’ As an occupant occasionally is ‘out of position’, airbag apparatuses which effectively restrain the occupant regardless of the occupant's position are advantageous.

During a front end collision, if the occupant is restrained by a seat belt, the occupant's upper torso bends at the waist and hits the primary airbag. However, depending on the design of the vehicle seat and force of the collision, there is a tendency for an occupant to slide forward along the seat and slip below the primary airbag, falling to the feet and leg compartment of the vehicle. Alternatively, the legs and knees of the occupant may slide or shift to one side of the seat or the other. The tendency is pronounced when the occupant is not properly restrained by a seat belt. This tendency may be referred to as “sliding”. Sliding often causes the occupant's upper torso to bend at the waist but not in a direction perpendicular to the primary airbag. When the occupant slides, the primary airbag is less effective in protecting the occupant.

Sliding is more prevalent in vehicles which have large leg room compartments. Vehicles which have restricted leg room, such as sports cars, have a lower sliding tendency. In vehicles like sports cars, the distance between the legs and knees of the occupant and the instrument panel is shorter than the distance in vehicles like sport utility vehicles or trucks. In an accident in a sports car, the knees of the occupant often strike the instrument panel. The instrument panel prevents sliding. Generally, the material of the sports car instrument panel defonns to some degree to help protect the legs and knees of the occupant. The area of the instrument panel which is impacted is called the knee bolster.

In order to prevent sliding in vehicles with large leg room compartments, a knee airbag system has been developed. A knee airbag system is generally positioned in the lower portion of the instrument panel. Knee airbag systems allow vehicle manufacturers to design vehicles with more leg room and still have safety comparable to that of vehicles with less leg room.

The knee airbag system includes an inflator, a housing, an airbag, and a trim cover panel. The housing is a conventional enclosure for securing the knee airbag components to the vehicle. The housing stores the knee airbag system components while the airbag is deflated and not in use.

The airbag provides the main structure for protecting the occupant. The bag is generally made of flexible fabric material. The material is generally a weave of nylon and/or polyester. Generally, multiple pieces of fabric are sewn together to form an airbag. Alternatively, the material may be woven to create a one piece airbag.

The trim cover panel is a panel which covers the airbag and inflator within the housing and presents an aesthetic trim surface to the vehicle occupant. The trim cover panel is connected to the housing such that the pressure of the inflating airbag pushes the trim cover panel out of the way. Often, the trim cover panel is attached by a hinge on one side and a fastener on the other.

The inflator, once triggered, uses compressed gas, solid fuel, or their combination to produce rapidly expanding gas to inflate the airbag. As with conventional airbag systems, a knee airbag is a large textile bag which the gas inflates like a balloon. The inflated knee airbag occupies a generally rectangular volume of the vehicle leg compartment. The knee airbag system may also include a fixed panel, called a load distribution panel (‘LDP’) or knee bolster panel. The LDP is generally made of foam and hard plastic surrounding a metal substrate. The LDP provides support to prevent sliding.

Generally, two designs are used in knee airbag systems. The first design concentrates on moving a piece of rigid material or LDP, similar to the material of the instrument panel in a sports car, close to the occupant's knees and legs creating leg and knee support (‘LDP designs’.) The second design does not use an LDP. This design 19 relies on the knee airbag to provide the necessary knee and leg support. (‘Non-LDP design’)

LDP designs are configured to rapidly move the LDP from a resting pre-accident position in the instrument panel to a position immediately in front of the occupant's knees and legs during an accident. These systems secure the housing behind the LDP in the instrument panel. The inflator and airbag are secured within the housing Generally, the LDP is secured to the airbag. The LDP may serve both as an LDP and a trim cover panel. Alternatively, a separate trim cover panel may be attached to the front of the LDP. Once the airbag is triggered, the inflator fills the airbag with gas. The inflating airbag pushes the LDP forward and closer to the knees and legs of the occupant. Once the airbag is fully inflated, the LDP is only a few inches from the knees and legs of the occupant.

The non-LDP design relies primarily on the airbag to provide the necessary support to prevent sliding. There is no LDP between the airbag and the occupant. The knee airbag system is mounted in the instrument panel as in the previous design. Just as with a primary airbag, the inflated knee airbag comes in direct contact with the occupant. The volume of gas within the knee airbag and the attachment of the knee airbag to the housing provide the needed support. The non-LDP design is simpler but provides minimal protection from sliding.

The non-LDP design is not generally as effective as the LDP design. This is because of the difficulty in using a flexible gas filled airbag to stop moving rigid legs and knees. When an inflated knee airbag, without rigid support, contacts the legs, the flexible airbag material wraps around each leg. This deformation allows each leg to travel some distance into the airbag before the volume of gas within the bag effectively stops the forward travel. This distance may be great enough that the legs of the occupant slide off the knee airbag and sliding results. If the occupant's legs are ‘out of position’ then the risk of sliding with this design is even greater. Additionally, knee airbags which present a curved surface once inflated increase the likelihood the knees and legs will slide off the airbag resulting in sliding. The flexible knee airbag lacks the rigid support necessary to prevent sliding.

An improvement to the non-LDP design is to add some form of rigid support. One technique is to use rigid slats. Slats are long rectangular pieces of rigid material such as plastic, aluminum, hard rubber, and the like. The slats are sewn, woven or otherwise attached to the surface of the airbag. Once the airbag is inflated, the slats act together to present a more rigid structure similar to a LDP. The slats evenly distribute the load of the impacting legs across the whole surface of the airbag. Even distribution of the load causes less deformation of the rectangular shape of the knee airbag. The legs and knees travel less distance into the airbag. The surface of the inflated knee airbag using slats functions as a rigid structure.

These designs have significant limitations. LDP designs involve complicated systems for attaching the LDP to the knee airbag. Attachment of the LDP is important because the design requires that a stable LDP be presented to the occupant's legs. Failure to do so creates the same limitations as those in non-LDP designs. LDP designs also require more parts and more skill in assembly than non-LDP designs. The attached LDP also limits the flexibility vehicle manufacturers have in designing the instrument panel. Generally, the knee airbag system must have a surface area at least the size of the LDP. But, one of the more significant limitations of LDP designs is that, although the LDP deforms on impact to some degree, the rigid LDP could cause some injury to the occupant's legs and fragile knee joints.

Non-LDP designs suffer from the inefficiencies discussed above. In addition, non-LDP designs using slats present a more rigid structure but likewise may result in a more significant injury to occupant's legs and knees. The slats make the design more complicated. Non-LDP designs require more materials, and more skilled workers to assemble the knee airbag systems. Generally, each rigid slat extends the length of the surface of the inflated airbag. To accommodate the lengths of these slats the housing must be at least as long as the slats which are attached to the folded airbag stored in the housing. A dimension requirement of the housing interferes with the flexibility an instrument panel designer has in positioning the knee airbag system.

Accordingly, it would be an advancement in the art to provide a soft-surface inflatable knee bolster airbag system which prevents sliding while providing a soft surface for contacting a vehicle occupant's legs and knees. A further advancement in the art would be to provide a soft-surface inflatable knee bolster airbag system which provides an even distribution of the impact force of the occupant's knees and legs by using a fixed LDP and a knee airbag. It would be another advancement in the art to provide a soft-surface inflatable knee bolster airbag system which functions even though the occupant's legs and knees are ‘out of position’. A further advancement in the art would be to provide a soft-surface inflatable knee bolster airbag system which is compact, simple, and has fewer parts. The present invention provides these advancements in a novel and useful way.

### BRIEF SUMMARY OF THE INVENTION

The apparatus of the present invention has been developed in response to the present state of the art, and in particular, in response to the problems and needs in the art that have not yet been fully solved by currently available soft-surface inflatable knee bolster airbags. Thus, the present invention provides a soft-surface inflatable knee bolster airbag system which provides a soft surface to impact the vehicle occupant's legs and knees, uses a fixed LDP to provide the necessary support, is simple, easy to fabricate, and offers flexibility in the design of vehicle interiors.

In one embodiment of the present invention, the soft-surface inflatable knee bolster airbag system includes an airbag. The airbag may take various forms, each of which provide a soft surface to engage the knees and legs of a vehicle occupant. The airbag is configured in the shape of a curtain. The inflated airbag is generally rectangular in shape and includes a plurality of long rectangular channels formed inside the airbag. Alternatively, the inflated airbag may be of a circular or polygonal shape. The channels may be formed by sewing dividing walls within the airbag. The dividing walls may be made of the same textile material as the airbag. Alternatively, the channels may be formed by weaving or welding the airbag such that a portion of the front surface is connected to a back or side surface of the airbag.

The channels within the airbag may also be arranged in various configurations. For example, the channels may be in parallel horizontally or vertically or the channels may form a star shaped design inside the airbag. Alternatively, the channels may take various other shapes depending on how the interior of the airbag is divided.

Alternatively, the airbag interior may be divided into a plurality of chambers formed in the same manner as the channels. The chambers may be of varied configurations while still presenting a generally flat rectangular front surface when the airbag is inflated. The airbag may be configured with chambers such that openings and holes between sealed chambers of the airbag exist. These openings and holes allow the airbag to present a soft front surface close to the occupant's legs and knees. But, the openings and holes allow the airbag to perform the soft surface presentation function using less inflator gas than without openings.

The various configurations of the airbag within the scope of the present invention provide flexibility in the design of the remaining soft-surface inflatable knee bolster airbag system components. The soft-surface inflatable knee bolster airbag system further includes an inflator, a trim cover panel, and a housing. The housing stores the airbag and inflator and connects the airbag to the instrument panel of the vehicle. The trim cover panel, as described above, closes the housing and protects the soft-surface inflatable knee bolster airbag system components while in storage. The inflator is configured to quickly inflate the airbag with gas. The design of the airbag influences the design of the inflator and housing and the location of the housing within the instrument panel. Airbags with chambers and openings, as discussed above, may use smaller inflators and housings because they use less gas and take up less space in the housing. This allows the whole soft-surface inflatable knee bolster airbag system to be smaller.

In the preferred embodiment, the airbag is configured such that, upon inflation, the airbag cooperates with a fixed load distribution panel (‘LDP’) to restrain the legs and knees of the occupant. The housing containing the soft-surface inflatable knee bolster airbag is located above the LDP within the lower portion of the instrument panel. Once the inflator is triggered, the inflating airbag forces open the trim cover panel and descends into the space between the occupant's lower extremities and the fixed LDP. The airbag inflates from the top side of the rectangular airbag rather than the middle of the airbag as in conventional airbag systems. Once inflated, the airbag occupies the majority of the rectangular space of the leg compartment of a vehicle and is aligned in parallel with the LDP. The rear surface of the airbag abuts the LDP and the front surface is a few inches from the occupant's knees and legs. Because the whole rectangular rear surface contacts the LDP, the soft-surface inflatable knee bolster airbag system presents a soft front surface which has substantially the same support characteristics as inflatable knee bolster airbag designs which position the airbag behind the LDP (LDP-designs). The channels within the airbag ensure that a generally planar front surface is presented to ensure the knees and legs do not slide off the knee airbag. Alternatively, the channels in the airbag may be designed to form ‘T’ shaped sections in the front surface. The channels guide the knees and legs of the occupant towards the ‘T’ shaped sections which are centrally located in the airbag.

These and other features, and advantages of the present invention will become more fully apparent from the following description and appended claims, or may be learned by the practice of the invention as set forth hereinafter.

### BRIEF DESCRIPTION OF THE DRAWINGS

In order that the manner in which the above-recited and other advantages of the invention are obtained and be readily understood, a more particular description of the invention briefly described above will be rendered by reference to specific embodiments thereof which are illustrated in the appended drawings. Understanding that these drawings depict only typical embodiments of the invention, and are not therefore to be considered to be limiting of its scope, the invention will be described and explained with additional specificity and detail through the use of the accompanying drawings in which:

FIG. 1 is a perspective view of a vehicle instrument panel illustrating possible locations of the soft-surface inflatable knee bolster airbag system once installed within the instrument panel.

FIG. 2 is a perspective view of a vehicle instrument panel illustrating a driver's side soft-surface inflatable knee bolster airbag system and a passenger's side soft-surface inflatable knee bolster airbag system following deployment.

FIG. 3 is a perspective view of a vehicle instrument panel illustrating a driver's side soft-surface inflatable knee bolster airbag system and a passenger's side soft-surface inflatable knee bolster airbag system each illustrating a different knee airbag channel configuration.

FIG. 4 is a cut away side elevation view of a preferred embodiment of the present invention in various stages of operation.

FIG. 4A illustrates the soft-surface inflatable knee bolster airbag system prior to deployment.

FIG. 4B illustrates the soft-surface inflatable knee bolster airbag system during initial stages of deployment.

FIG. 4C illustrates the soft-surface inflatable knee bolster airbag system during a middle stage of deployment.

FIG. 4D illustrates the soft-surface inflatable knee bolster airbag system with the airbag fully inflated and positioned.

FIG. 5 is a cross-sectional view of alternative embodiments of the present invention illustrating several configurations of internal airbag chambers.

FIG. 5A illustrates the alternative embodiment with internal chambers prior to deployment.

FIG. 5B illustrates the alternative embodiment with internal chambers after deployment.

FIG. 5C illustrates yet another alternative embodiment after deployment with internal chambers which are secured to each other to form a hole behind the front portion of the inflated airbag.

FIG. 6 is a rear elevation view illustrating alternative embodiments of the present invention illustrating several configurations of airbag chambers which provide holes and/or openings behind the front surface of the airbag.

FIG. 6A illustrates an alternative embodiment with openings between two chambers of the airbag.

FIG. 6B illustrates an alternative inflator orientation for the embodiment of FIG. 6A.

FIG. 6C illustrates an alternative embodiment with openings and holes between two chambers of the airbag.

### DETAILED DESCRIPTION OF THE PREFERRED EMBODIMENTS

The present invention can be better understood with reference to the drawings where like parts are designated with like numerals throughout.

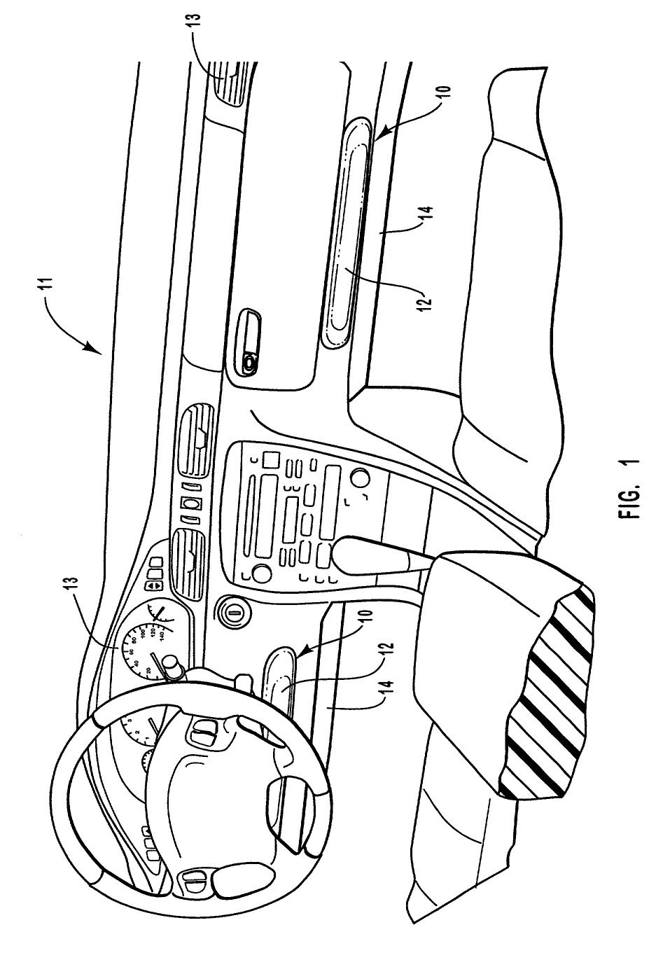

Reference is now made to FIG. 1 which illustrates a vehicle instrument panel 11 with indicators for the different locations of soft-surface inflatable knee bolster airbag systems 10. A soft-surface inflatable knee bolster airbag system 10 is generally located towards the bottom portion of the vehicle instrument panel 11. The system 10 may be installed on the driver's side to protect a driver, on the passenger's side to protect a passenger, or on both sides.

Preferably, a soft-surface inflatable knee bolster airbag system 10 is compact in design and space requirements such that the system 10 fits behind a trim cover panel 12 as illustrated. Alternatively, the system 10 may also be positioned in the instrument panel 11 at a point central to a load distribution panel (‘LDP’) 14. FIG. 1 illustrates the size of the soft-surface inflatable knee bolster airbag system 10 in relation to the other components positioned in the instrument panel 11.

Generally, it is desired that instrument panel's 11 component occupant facing surfaces 13 be as compact as possible. The vehicle design generally provides sufficient space between the front of the instrument panel 11 and the vehicle firewall (not shown) that depth of instrument panel 11 components is not an issue. Compact occupant facing surfaces 13 allow vehicle instrument panel 11 designers more flexibility in arranging the instrument panel 11 layout than they would have otherwise.

The present invention has dimension requirements which offer flexibility and fit well into instrument panel 11 designs. A trim cover panel 12 conceals the main system 10 components from the occupant. The length and height dimensions of the trim cover panel 12 are representative of the front dimensions of the main components of the soft-surface inflatable knee bolster airbag system 10. In the preferred embodiment, the trim cover panel 12 has a high length to height ratio. This means the length is considerably greater than the height. Specifically, the length is in the range of 18 to 36 inches while the height is in the range of 4 to 6 inches. These ranges result in the trim cover panel 12 of the soft-surface inflatable knee bolster airbag system 10 occupying a narrow rectangular area. Alternatively, the soft-surface inflatable knee bolster airbag system 10 may occupy various other circular and polygon shapes. Trim cover panels 12 which have dimensions meeting these ranges tend to have lengths which are about five times their respective heights.

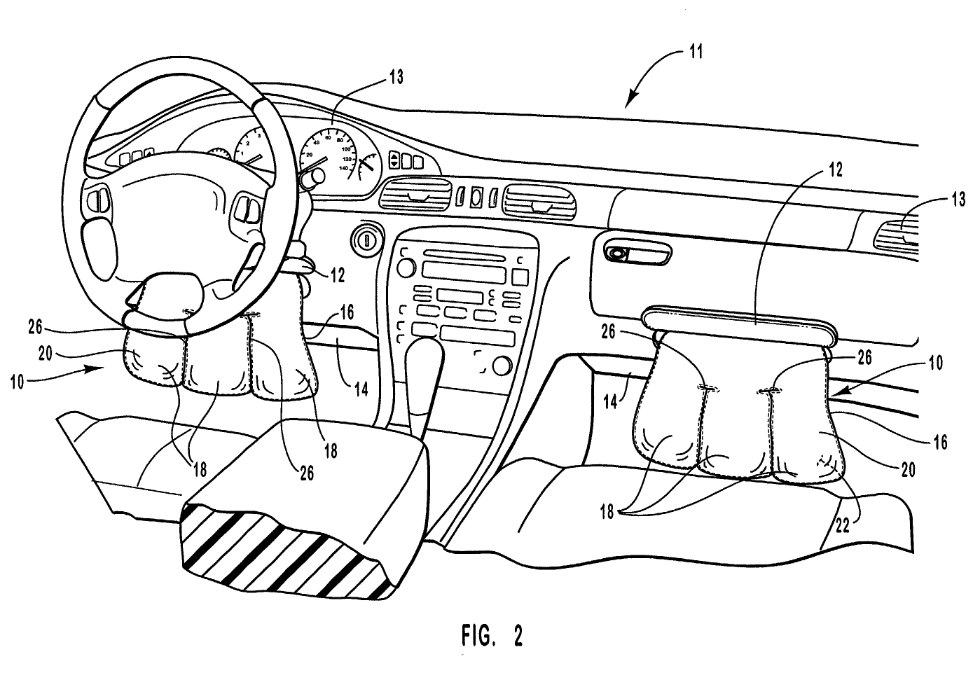

FIG. 2 illustrates the importance of the location of the soft-surface inflatable knee bolster airbag system 10. The location of the soft-surface inflatable knee bolster airbag system 10 is directly related to the location of the LDP 14. Preferably, the soft-surface inflatable knee bolster airbag system 10 is located directly above the LDP 14. At this location, the airbag 16 descends under the force of gravity and the inflation force created by the inflator (not shown) such that the inflated airbag 16 is positioned directly in front of the LDP 14. In this manner, the soft-surface inflatable knee bolster airbag system 10 utilizes the LDP 14 for structural support.

Referring still to FIG. 2, the soft-surface inflatable knee bolster airbag system may be configured such that one or more chambers 18 are formed inside the airbag 16. The chambers 18 are formed by securing the front surface 20 of the airbag 16 to the rear surface 22. Alternatively, the front surface 20 may be secured to an interior divider which is then attached to the rear surface 22 of the airbag 16. Securement is accomplished by common techniques in the industry including glueing, sewing, welding, and the like. As a result of securement techniques creating the chambers 18, T-shaped depressions 26 may be formed. The securement techniques allow that the depressions 26 may have alternative shapes such as ‘L’, ‘U’, ‘H’, ‘O’, and the like. Preferably, the depressions 26 are sized to retain a proportional letter shape and extend substantially to the height of an LDP 14.

The depressions 26 cooperate with the chambers 18 to serve two purposes. First, they guide the occupant's legs and knees such that on impact the legs and knees remain in contact with the airbag 16 rather than sliding off to one side. The depressions 26 and chambers 18 aide in moving knees and legs of an occupant who is ‘out of position’ such that the knees and legs are in position at the time of impact with the airbag 16.

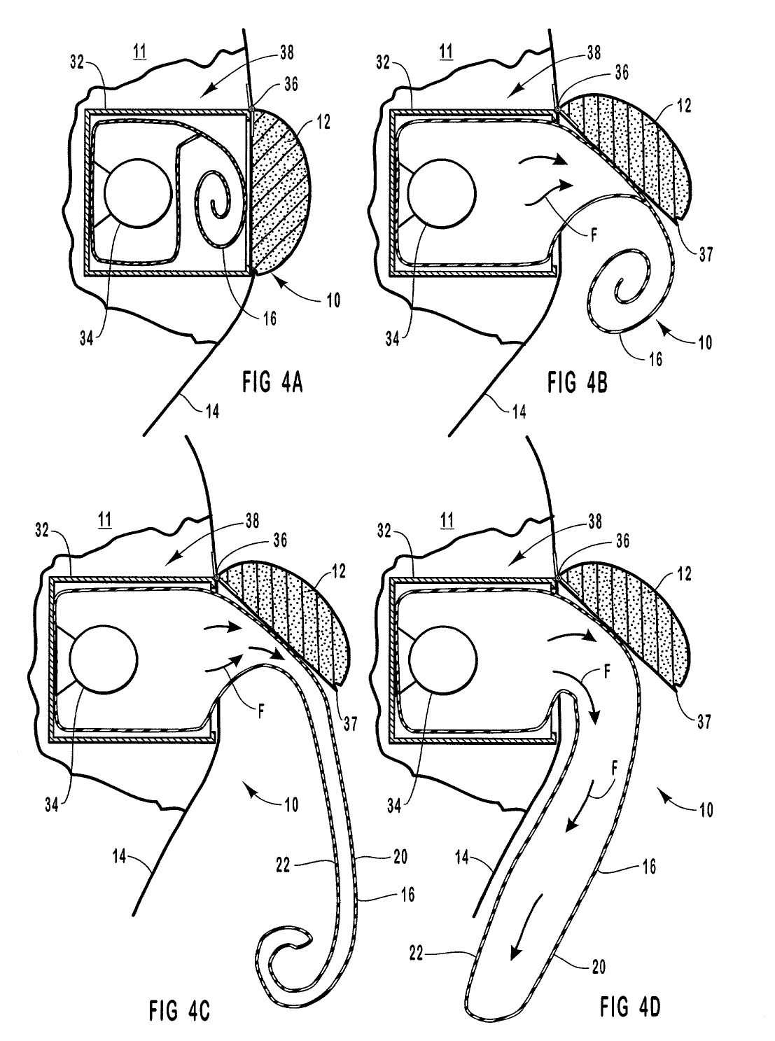

Second, these components reduce the volume of space between the occupant and the LDP 14 which the airbag 16 must occupy to function properly. By reducing the volume, less inflation gas is required. Therefore, the inflator 34 (See FIG. 4) may be smaller. A smaller inflator 34 allows the housing 32 (See FIG. 4) to be smaller. A smaller housing 32 means the whole soft-surface inflatable knee bolster airbag system 10 is smaller. A smaller system 10 allows more flexibility in vehicle instrument panel 11 design.

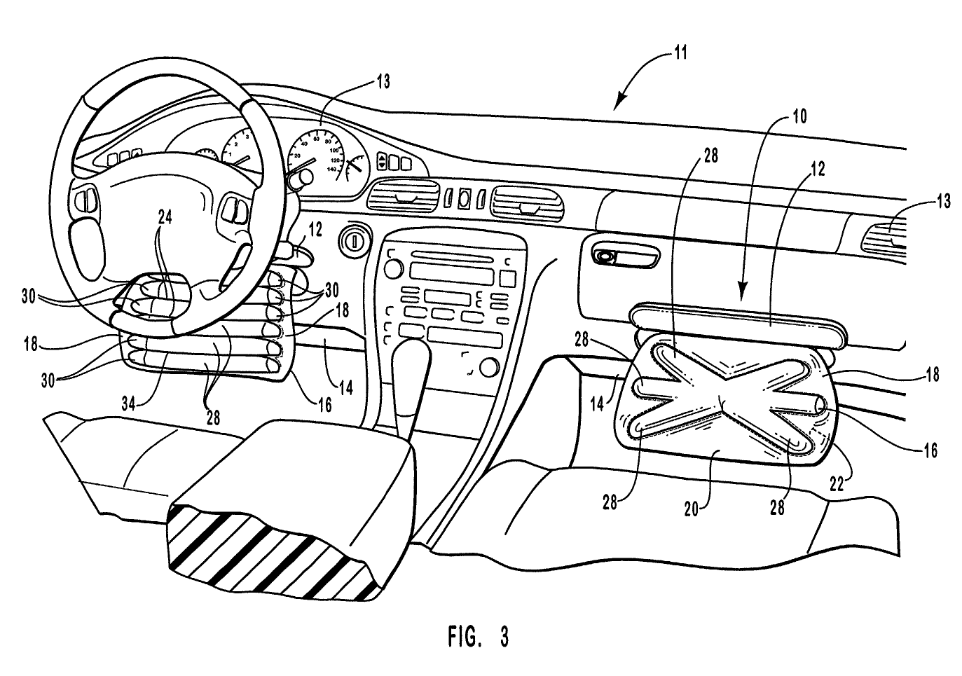

FIG. 3 illustrates airbags 16 having tubes 28 formed therein. Tubes 28 are generally small long rectangular enclosures within the airbag 16. Tubes 28 may be divisions formed within chambers 18. Gas inflating the chamber 18 inflates all the tubes 28 through tube openings 30. Alternatively, a first tube 28 is connected to an inflator 34 and the remaining tubes 28 are connected to each other such that gas inflating the first tube 28 inflates all the tubes 28 formed in the airbag 16.

Generally, tubes 28 are made from the same material as the airbag 16. The tubes 28 may be formed using similar techniques to techniques used to form chambers 18. Preferably, the tubes 28 are formed by welding or sewing two pieces of textile airbag material together. The pattern of welding or sewing is such that a compartment is formed between the two pieces of material and the perimeter of the compartment forms tubes 28 once the airbag 16 is inflated. Alternatively, the tubes 28 may be formed by weaving the tubes 28 into the airbag 16. Upon inflation, the gas leaves the inflator 34 and enters the chambers 18. From the chambers 18, the gas passes through the tube openings 30 to fill each individual tube 28.

The different embodiments on the driver's and passenger's side of the vehicle instrument panel 11 in FIG. 3 illustrate airbags 16 having one or more tubes 28. The tubes 28 may be organized in various configurations. In the inflated airbag 16 on the driver's side, the tubes 28 are aligned horizontally one above the other. Each tube 28 includes at least one tube opening 30. A tube opening 30 is a hole in the tube 28. Tube openings 30 may be formed when the tube 28 is formed. Alternatively, the tube opening 30 may be formed by cutting a hole in the tube 28 once the tube 28 is formed. The tube opening 30 may be located at any point along the tube 28 so long as the tube opening 30 provides fluid communication between a chamber 18 receiving inflation gas and the inside of the tube 28.

In the embodiment illustrated on the passenger's side, the tubes 28 are configured in the shape of a star. The opening 30 is positioned on the end of one of the tubes 28. The tubes 28 interconnect at a point central to the star shape to allow inflation gas to fully inflate each tube 28. Alternatively, the tubes 28 do not interconnect at a central point but instead have tube openings 30 on an end in fluid communication with a chamber 18.

Referring still to FIG. 3, chambers 18 cooperate with tubes 28 to provide a generally flat front surface 20 and rear surface 22 for the airbag 16. Due to the flexible material used to make airbags 12 a conventional airbag 16 inflates to present a surface with a high degree of curve, much like the surface of a balloon. Such a high degree of curve in a knee bolster airbag context is undesirable. It is desirable to present a flat surface to accommodate different sized occupants and positions of knees and legs.

A flat front surface 20 of a knee bolster engages most of the knee and lower leg at nearly the same time during impact. The tubes 28 and chambers 18 cooperate to restrain the front surface 20 and rear surface 22 of the airbag 16 upon inflation. A generally flat rear surface 22 allows the present invention to leverage the advantages of rigid LDPs 14. The flexibility of the airbag 16 material and the interconnected tubes 28 forms an inflated airbag 16 which is flat on two sides much like a curtain.

Reference is now made to FIG. 4, wherein FIGS. 4A, 4B, 4C, and 4D illustrate cut away side elevation views of the various stages of deployment for a soft-surface inflatable knee bolster airbag system 10. The system 10 includes a housing 32, an inflator 34, an airbag 16, a trim cover panel 12, and a load distribution panel 14 (‘LDP’).

As seen in FIG. 4A, an inflator 34 is attached to a housing 32. The housing 32, in cooperation with the trim cover panel 12, stores the inflator 34 and airbag 16 until the system 10 is initiated by the electronic control unit (‘ECU’), as discussed above. The housing 32 secures a majority of the members of the system 10 to the vehicle. Housings 32 are common in the industry. A housing 32 allows the main members of the system 10 to be assembled at one location and installed in the vehicle at second location. Housings 32 may be of a generic shape, or may be designed specifically to fit the design of the lower instrument panel 11 of a particular type of vehicle. The location of the housing 32 and the functional requirements of the system 10 allow for the housing 32 to be in the shape of a long thin rectangle. Two opposing sides of the housing 32 are substantially shorter than the other two opposing sides. A long thin rectangular shape is optimal because this allows more instrument panel front surface area for other vehicle components. Alternatively, the shape may be circular or polygonal.

FIG. 4A also illustrates a trim cover panel 12. The trim cover panel 12 conceals the airbag 16 and other internal components. The trim cover panel 12 also provides a decorative appearance for the installed airbag system 10. Generally, the trim cover panel 12 is made of pre-formed hard plastic. The trim cover panel 12 may be made of wood, metal, foam, or like materials common in the industry. The shape and size of the trim cover panel 12 generally depends on the size of the assembled airbag module and the size of the surface area within the lower portion of the instrument panel, which the housing 32 occupies. In one embodiment, the trim cover panel 12 is of a thin rectangular shape. For each vehicle model the shape, size and decor of the trim cover panel 12 may vary.

The trim cover panel 12 is attached to the housing 32 by a trim cover panel fastener 36. Alternatively, the trim cover panel 12 may be attached to the housing 32 by various fastening techniques common in the industry. Such techniques include tree clips, snaps, rivets, or the like. The trim cover panel fastener 36 must allow trim cover panel 12 to easily be moved to open the housing 32. The housing 32 must easily open to allow the inflating airbag 16 to obtain its optimal position in the lower leg compartment of the vehicle. Preferably, the trim cover panel fastener 36 cooperates with structure for tethering the trim cover panel 12 to the housing 32 when the airbag inflates 12. In the preferred embodiment, a trim cover panel fastener 36 configured as a hinge serves the tethering and fastening functions needed for the trim cover panel 12.

FIG. 4A illustrates the system 10 fully assembled and installed in an optimal position inside the instrument panel of a vehicle. The airbag 16 is connected to the inflator 34 which is connected to the housing 32. These connections are made by conventional means including clamps, screws, nuts and bolts, welding, and the like. The trim cover panel 12 is fastened to the housing 32 by the trim cover panel fastener 36 embodied as a hinge. Preferably, the airbag 16 is then rolled from the unattached end toward the attached end and placed in the opening between the inflator 34 and the trim cover panel 12. Alternatively, the airbag 16 may be folded and placed into the housing 32. The trim cover panel 12 is then closed to keep the airbag 16 within the housing 32. Opposite the trim cover panel fastener 36 the trim cover panel 12 may be secured to the housing 32 by wedging a lip 37 (see FIGS. 4B, 4C, and 4D) of the trim cover panel 12 between the LDP 14 and the body (not shown) of the instrument panel 11. The aforementioned members make up a knee airbag module 38. The knee airbag module 38 is then installed into an instrument panel 11 as illustrated.

FIG. 4B illustrates the soft-surface inflatable knee bolster airbag system 10 and its members at a beginning phase of deployment of the airbag 16. The electronic control unit (‘ECU’ not shown) has signaled the inflator 34 to inflate the airbag 16. The inflator 34 is injecting gas into the airbag 16 at a very high velocity. As illustrated in FIG. 4B, the force F of the gas inflating airbag 16 has moved the trim cover panel 12 on its hinge, trim cover panel fastener 36, such that the housing 32 is now open. The force F of the gas inflating airbag 16 and gravity begin to unroll the airbag 16 into the lower leg compartment.

In FIG. 4C, the inflating airbag 16 is almost completely unrolled. The housing 32 is kept open by the inflating airbag 16 biasing the trim cover panel 12. Next, the airbag 16 begins to fill with gas (not shown).

FIG. 4D illustrates the position of members of the soft-surface inflatable knee bolster airbag system 10 prior to and including the point when the airbag 16 is completely inflated. The inflated airbag 16 is positioned in front of a LDP 14. The generally flat front surface 20 and rear surface 22 of the inflated airbag 16 utilize the characteristics of the LDP 14.

An LDP 14 provides a large rigid surface to distribute and absorb the force of the legs and knees. The large rigid surface allows less travel of the legs and knees in an accident which prevents sliding. The LDP 14 is preferably a rectangular shaped panel. Alternatively, the LDP 14 may be a thin rigid rectangular plate, a rod having a polygonal cross-section, or other similarly shaped material. To conserve space and reduce weight, the rigid LDP 14 is preferably made as strong and as light as possible. Typically, the LDP 14 is made from wood, metal, Styrofoam®, hard plastic, or the like surrounding a metal or hard plastic substrate.

The inflated airbag 16 forms a curtain or wall between the occupant and the LDP 14. Once the occupant impacts the airbag 16, the generally flat rear surface 22 of the airbag 16 provided by the tubes 28 and chambers 18 (See FIG. 3) contacts the LDP 14. The generally flat rear surface 22 allows the impact force of the occupant's knees and legs on the airbag 16 to be evenly distributed across the surface of the rigid LDP 14. An even distribution of the impact forces on the rigid LDP 14 results in less impact stress on the legs and knees of the occupant. In this way, the soft-surface inflatable knee bolster airbag system 10 provides a soft surface to impact the knees and lower legs of the occupant and evenly distributes the impact force to reduce the likelihood of injury.

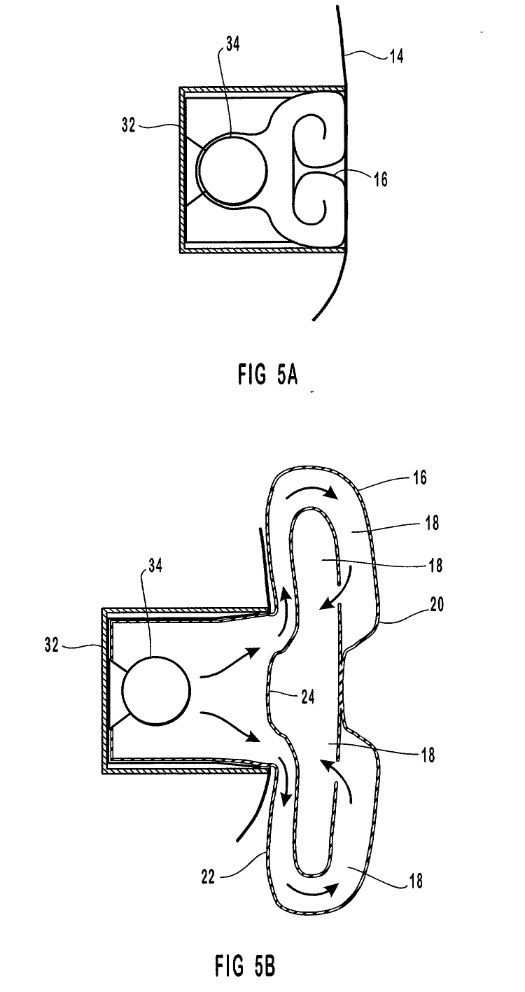

FIG. 5 is a cross-sectional view of alternative embodiments of the a knee airbag module 38 for use in a soft-surface inflatable knee bolster airbag system 10. In these embodiments, the housing 32 and inflator 34 are positioned such that they are behind and central to the inflated airbag 16. The knee airbag module 38 is preferably located substantially in the middle of an LDP 14 positioned in the lower portion of the instrument panel 11. FIGS. 5A and 5B are, respectively, illustrate of one embodiment of a knee airbag module 38 before and after inflation of the airbag 16. FIG. 5C illustrates an alternative embodiment of the invention.

FIG. 5A illustrates a knee airbag module 38 prior to inflation of the airbag 16. The housing 32 is connected to the inflator 34 which is connected to the airbag 16. These connections are all of the same nature as those in FIG. 4. The airbag 16 is rolled or folded from the outer edge of the airbag 16 towards the middle of the airbag 16.

FIG. 5B illustrates the knee airbag module 38 once it is fully inflated. In this embodiment, chambers 18 are formed within the airbag 16 in the same manner as the chambers 18 described above. These chambers 18 serve to provide a generally flat front surface 20 for impacting the legs and knees of the occupant.

Preferably, the knee airbag module 38 of FIG. 5B is secured inside a cavity (not shown) of an LDP 14 such that the trim cover panel 12 front surface is flush with the front surface of the LDP 14. With the knee airbag module 38 in the preferred position, the rear surface 22 of the inflated airbag 16 will impact the LDP 14 once the occupant impacts the airbag 16. The chambers 18 within the airbag 16 provide a generally flat rear surface 22. The generally flat rear surface 22 allows the knee airbag module 38 to leverage the characteristics of the LDP 14 just as in the embodiment of FIG. 4.

FIG. 5C illustrates an alternative embodiment wherein the airbag 16 is fully inflated. FIG. 5C has a different configuration of chambers 18 within the airbag 16 from FIGS. 5A and 5B. The inflator 34, housing 32 and airbag 16 are connected as discussed above. The knee airbag module 38 includes a hole 40. The hole 40 is formed by securing the front surface 20 of the airbag 16 to the inflator 34. Securing the front surface 20 of the airbag 16 to the inflator 34 creates two chambers 18 which are connected to the inflator 34 such that gas escaping the inflator 34 fills the two chambers 18. The two chambers 18 are then secured to each other at chamber connection 42. Preferably, chamber connection 42 is formed by stitching an end of a first chamber 18 to an end of a second chamber 18. Alternatively, the two chambers 18 may form a chamber connection 42 by other techniques common in the industry. These techniques include welding, glueing, and the like.

The knee airbag module 38 illustrated in FIG. 5C requires less gas to inflate than conventional knee airbag modules 38. The knee airbag module 38 still provides protection comparable to conventional knee airbag modules 38. Knee airbag modules 38 which require less gas allow for smaller inflators 34. This allows for smaller knee airbag modules 38 with the accompanying advantages in instrument panel 11 design flexibility as discussed above.

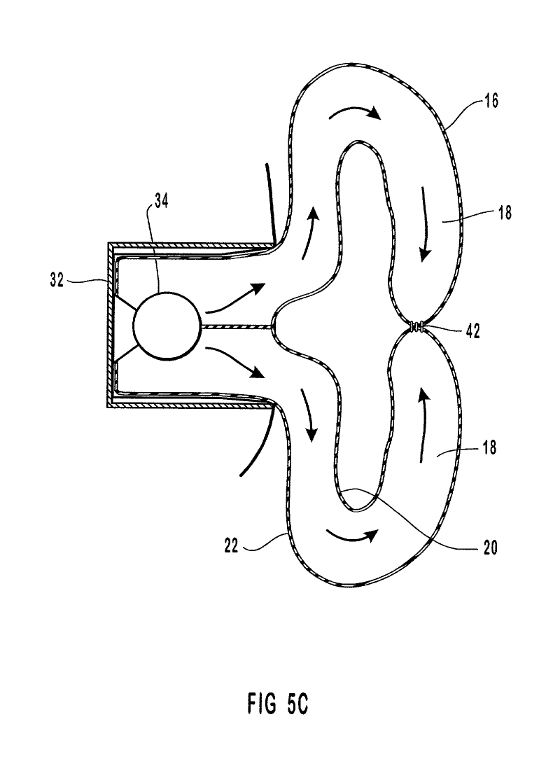

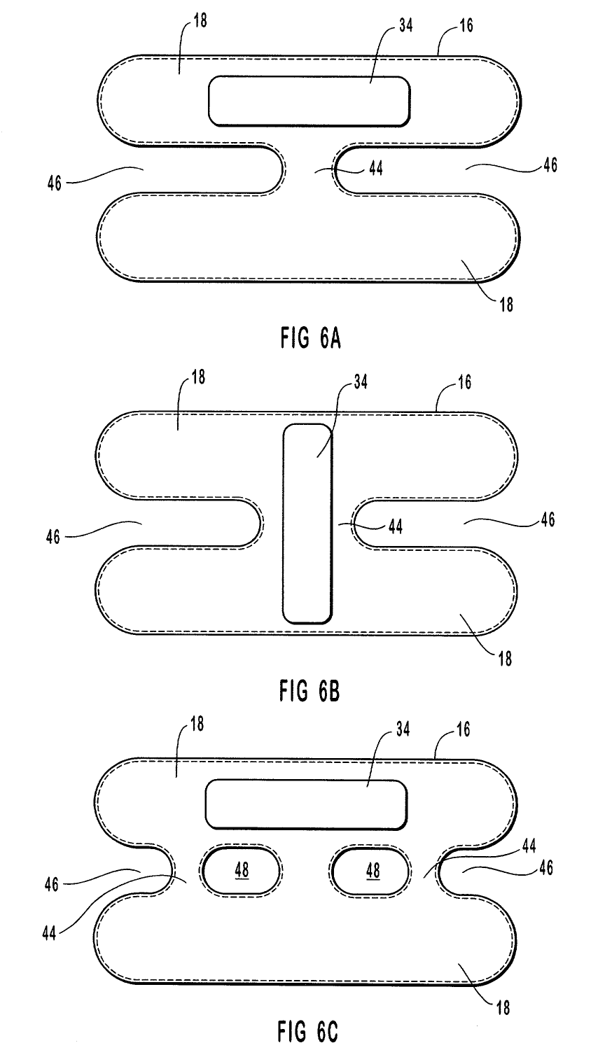

FIG. 6 is a rear elevation view illustrating alternative designs of the airbag 16. FIGS. 6A and 6C show alternative chamber 18 designs. FIG. 6B illustrates a different orientation of the inflator 34.

In FIG. 6A, an airbag 16 is illustrated having two chambers 18 connected by a chamber passage 44. A chamber passage 44 is a portion of the airbag 16 between two chambers 18 which allows inflation gas to easily pass from one chamber 18 to the other. The chamber passage 44 is sized to allow unimpeded flow of gas between the two connected chambers 18.

Preferably, the two chambers 18 and chamber passage 44 are formed by welding two pieces of airbag material together along an ‘H’ shaped perimeter. The material between the legs and arms of the ‘H’ is then cut away. Alternatively, the material may be left between the arms and legs of the ‘H’. The cut away portions of the airbag form openings 46 on both sides of the chamber passage 44. The openings 46 and chamber passage 44 together allow the airbag 16 to protect the occupant in the same space as the preferred embodiment yet require less inflation gas. The advantages of using less inflation gas are described above. Alternatively, the chamber passages 44 may be formed within the airbag 16 in a manner similar to that used to form chambers 18, as discussed above.

To achieve the orientation of the airbag 16 illustrated in FIG. 6A, the ‘H’ is turned 90 degrees. Next, a first chamber 18 of the ‘H’ is fitted to an inflator 34 such that inflation gas flows easily from the inflator 34 into the first chamber 18. Preferably, the first chamber 18 is the bottom chamber 18. Alternatively, the first chamber 18 may be the top chamber 18. The chamber passage 44 allows gas to flow from the first chamber 18 into the second chamber 18.

FIG. 6B illustrates the same airbag 16 design as in FIG. 6A. In FIG. 6B, the inflator 34 is in alignment with the cross-bar of the ‘H’ rather than one side. In this embodiment, the inflator 34 is connected to both chambers 18 and the chamber passage 44. Alternatively, the inflator 34 is connected to one chamber 18 or the other. In another alternative, the inflator 34 may be connected to a chamber passage 44 and one chamber 18.

Referring now to FIG. 6C, the idea of a chamber passage 44 is expanded to include a plurality of chamber passages 44 which form holes 48 between the outside chamber passages 44 and one or more internal chamber passages 44. FIG. 6C illustrates three chamber passages 44. Alternatively, there may be one or more chamber passages 44 connecting one or more chambers 18.

As in FIGS. 6A and 6B, the holes 48 serve the same purpose as the openings 46, discussed above. Alternatively, the holes 48 may be sized and configured such that they receive the knees of an average size occupant. The holes 48 may be sized and shaped such that the knees of an average size occupant are restrained within the holes 48. Such a configuration may prevent the knees from contacting an LDP 14 positioned behind the airbag 16. This would further help to protect the knees of the occupant.

Referring now to FIGS. 1-6 generally, the components described above comprise the soft-surface inflatable knee bolster airbag system 10. In order to practice the present invention, a housing 32, an inflator 34, a load distribution panel (‘LDP’) 14, and an airbag 16 are provided. The airbag 16 is a textile bag common in the industry. The airbag 16 is sized and shaped to operably position itself between the LDP 14 and an occupant's legs once inflated. The inflator 34 is secured within the housing 32. The airbag 16 is secured to the inflator 34 or housing 32 such that the airbag 16 is in fluid communication with the inflator 34. The airbag 16 is rolled up or folded and placed inside the housing 32. The housing 32 is closed by a trim cover panel 12. The LDP 14 is installed in an instrument panel 11 of a vehicle. Next, the housing 32 is secured to the instrument panel 11 directly above the LDP 14.

Operation of the soft-surface inflatable knee bolster airbag system 10 is as follows. First, a vehicle with the system 10 installed is involved in an accident. Next, the ECU signals the inflator 34 to inflate the airbag 16. The inflator 34 begins to fill the airbag 16. The inflating airbag 16 forces open the trim cover panel 12. The airbag 16 fills in the space in the leg compartment of the vehicle between a LDP 14 and the occupant's lower legs and knees. Once inflated, the airbag 16 is aligned in parallel with and rests against the LDP 14. The front surface 20 of the airbag 16 is within a few inches of the occupant's knees and lower legs. The sudden deceleration of the vehicle causes the occupant to begin to slide. The legs and knees contact the front surface 20 of the airbag 16. The airbag 16 is pressed against the entire surface of the LDP 14. The LDP 14 and airbag 16 cooperate to prevent the knees and legs from impacting the LDP 14. The occupant is restrained from sliding and minimal damage to the occupant's knees and lower legs results.

The soft-surface inflatable knee bolster airbag system 10 provides a soft front surface 20 for impacting the knees and legs of an occupant. Additionally, the airbag 16 occupies the space in the lower leg compartment such that the impact load is substantially evenly distributed across the LDP 14. Furthermore, the soft-surface inflatable knee bolster airbag system 10 requires minimal front surface space in the instrument panel 11 of a vehicle.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by Letters Patent is:

1. A knee bolster airbag system comprising:
an airbag;
an inflator configured to inflate the airbag;
a housing for storage of the airbag and the inflator; and
wherein upon inflation the airbag provides a soft surface capable of engaging the lower extremities of a vehicle occupant.

2. A knee bolster airbag system as in claim 1, wherein the airbag is configured in the shape of a curtain.

3. A knee bolster airbag system as in claim 1, wherein the airbag comprises a plurality of chambers capable of distributing an impact force throughout the inflated airbag.

4. A knee bolster airbag system as in claim 1, wherein when installed in an automobile and upon inflation the airbag occupies a space between the vehicle occupant's legs and structural components of an instrument panel.

5. A knee bolster airbag system as in claim 4, wherein the structural components comprise a load distribution panel which provides support for the inflated airbag.

6. A knee bolster airbag system as in claim 1, wherein the installed system has a length within a range of 18 to 36 inches and a height within a range of 4 to 6 inches.

7. A knee bolster airbag system as in claim 1, further comprising a cover attached to the housing.

8. A knee bolster airbag system comprising:
a load distribution panel;
an airbag curtain configured such that when installed in an automobile and upon inflation the airbag curtain occupies an area between the knees of an occupant and the load distribution panel;
an inflator configured to inflate the airbag curtain; and
a housing for storage of the airbag curtain and the inflator.

9. A knee bolster airbag system as in claim 8, wherein the inflated airbag curtain provides a soft surface capable of engaging the lower extremities of a vehicle occupant.

10. A knee bolster airbag system as in claim 9, wherein the inflated airbag curtain provides a plurality of chambers capable of distributing an impact force throughout the inflated airbag curtain.

11. A knee bolster airbag system as in claim 10, wherein the airbag curtain is configured such that once inflated the airbag curtain forms at least one opening between the airbag curtain and the housing.

12. A knee bolster airbag system as in claim 11, wherein the at least one hole is formed in the inflated airbag curtain

13. A knee bolster airbag system as in claim 12, wherein inflating the airbag curtain positions the airbag curtain between the vehicle occupant's legs and the load distribution panel such that the load distribution panel provides support for the inflated airbag curtain.

14. A knee bolster airbag system as in claim 13, wherein the airbag curtain is folded and stored within the housing allowing the length of the housing to be about five times the height.

15. A knee bolster airbag system comprising:
an airbag;
an inflator configured to inflate the airbag;
a housing for storage of the airbag and the inflator; and
wherein the airbag comprises a plurality of chambers configured to engage the lower extremities of a vehicle occupant when installed in an automobile and inflated and capable of substantially equal distribution of an impact force imposed by the lower extremities.

16. A knee bolster airbag system as in claim 15, wherein the inflated airbag provides a soft surface capable of engaging the lower extremities of an occupant.

17. A knee bolster airbag system as in claim 15, wherein the inflated airbag occupies a space between the occupant's legs and a load distribution panel such that the load distribution panel provides support for the inflated airbag curtain.

18. A knee bolster airbag system as in claim 15, wherein the installed system has a length which is about five times the height.

19. A knee bolster airbag system as in claim 15, wherein the installed system occupies a narrow rectangular area.

20. A knee bolster airbag system as in claim 15, wherein the installed system occupies a polygonal area.

21. A knee bolster airbag system as in claim 15, wherein the installed system occupies a circular area.

22. A knee bolster airbag system as in claim 15, wherein the airbag is configured such that upon inflation the airbag restrains a vehicle occupant using a minimal quantity of inflation gas.

23. A knee bolster airbag system comprising:
a load distribution panel;
an airbag curtain configured such that upon inflation when installed in an automobile and inflated the airbag curtain is oriented parallel to the load distribution panel such that the load distribution panel provides support for the inflated airbag curtain which is absorbing the impact force imposed by the vehicle occupant's lower extremities;
an inflator configured to inflate the airbag curtain; and
a housing for storage of the airbag curtain and the inflator.
